(19) United States
(12) Patent Application Publication
(10) Pub. No.: US 2010/0278165 A1
(43) Pub. Date: Nov. 4, 2010

(54) RADIO TERMINAL AND RADIO COMMUNICATION METHOD

(75) Inventor: Kenji Kono, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/810,819

(22) PCT Filed: Dec. 26, 2008
(86) PCT No.: PCT/JP2008/073862

§ 371 Date: Jun. 25, 2010

(30) Foreign Application Priority Data
Dec. 27, 2007 (JP) 2007-338113

(51) Int. Cl. H04W 16/00

(52) U.S. Cl. 370/338

(57) ABSTRACT

The radio terminal comprises a base station communication unit (110) capable of direct communication with a specific wide-area communication network provided by a specific operator, an ad-hoc communication unit (120) capable of forming a first ad-hoc communication network (AH1) with a plurality of other mobile terminals (MS1 to 3), and an operator determination unit (133) for determining whether or not a first connected operator which provides a first connected wide-area communication network (WAN1) connected via the other mobile terminals (MS1 to 3) is the same as the specific operator. The operator determination unit (133) performs the determination on the basis of operator identification information included in a control signal. If the first connected operator is judged to be the same as the specific operator, the ad-hoc communication unit (120) forms the first ad-hoc communication network (AH1) with the other mobile terminals (MS1 to 3).

### TECHNICAL FIELD

The present invention relates to a radio terminal forming an ad-hoc communication network, and to a radio communication method used in the radio terminal.

### BACKGROUND ART

Heretofore, a radio communication network autonomously formed by multiple radio terminals, i.e., a so-called ad-hoc communication network has been known as one form of a wireless LAN (Local Area Network) (refer to Patent Document 1, for example). The multiple radio terminals forming the ad-hoc communication network are mutually communicable in the ad-hoc communication network.

Moreover, there has been known a communication system including an ad-hoc communication network and a connected wide area network (a mobile phone communication network or the like, for example) to which the ad-hoc communication network is connected (refer to Patent Document 2, for example). Such a connected wide area network is formed of a radio base station, a radio network controller, a core network and the like. A radio terminal forming the ad-hoc communication network is capable of connecting to the connected wide area network via another radio terminal.
Patent Document 1: Japanese Patent Application Publication No. 2005-79827 (Paragraph [0023], FIG. 1)
Patent Document 2: Japanese Patent Application Publication No. 2003-124876 (Paragraph [0049], FIG. 6)

### DISCLOSURE OF THE INVENTION

Here, generally speaking, since the wide area network is provided by a specific telecommunication operator, only a radio terminal which has previously signed a service agreement with the specific telecommunication operator is allowed to connect to the wide area network.

Accordingly, in the aforementioned communication system, among the multiple radio terminals forming the ad-hoc communication network, only the radio terminal which has previously signed a service agreement with the connected operator as the telecommunication operator providing the connected wide area network is allowed to connect to the connected wide area network. Specifically, during establishing the connection to the connected wide area network after forming the ad-hoc communication network, the radio terminal needs to receive authentication from an authentication server provided in the connected wide area network. In other words, a problem here is that, unless the radio terminal forms the ad-hoc communication network first, the radio terminal cannot know whether or not the radio terminal is allowed to connect to the connected wide area network connected to the ad-hoc communication network.

The present invention has been made to solve the aforementioned problem, and an objective of the present invention is to provide a radio terminal capable of knowing whether or not the radio terminal is allowed to connect to the connected wide area network connected to an ad-hoc communication network before formation of the ad-hoc communication network, and to provide a radio communication method used in the radio terminal.

The present invention has the following characteristics to solve the problems described above. First of all, a first characteristic of the present invention is summarized as a radio terminal comprising: a first communication unit (base station communication RF processor 112) configured to be directly communicable with a specific wide area network provided by a certain specific operator (operators A, B) being a specific telecommunication operator; a second communication unit (ad-hoc communication unit 120) configured to be capable of forming an ad-hoc communication network (first ad-hoc communication network AH) with one or more different radio terminals (different radio terminals MS1 to MS3); and a determination unit (operator determination unit 133) configured to determines whether or not a connected operator (first connected operator) is the same as the specific operator, the connected operator being a telecommunication operator providing a connected wide area network (first connected wide area network WAN1) connected to the radio terminal via the different radio terminal, wherein the second communication unit receives a control signal from the different radio terminal, the control signal including control information used in forming the ad-hoc communication network, the determination unit makes the determination on the basis of operator identification information included in the control signal and indicating the connected operator, and the second communication unit forms the ad-hoc communication network with the different radio terminal in a case where the determination unit determines that the connected operator is the same as the specific operator.

As described above, the radio terminal is capable of determining whether or not the connected operator is the same as the specific operator before forming the ad-hoc communication network with the different radio terminal. Accordingly, in a case where the service agreement with the connected operator has not been signed for the radio terminal, the radio terminal can know before forming the ad-hoc communication network with the different radio terminal that the radio terminal is not allowed to use the connected wide area network to which the radio terminal is to be connected via the different radio terminal.

A second characteristic of the present invention is according to the first characteristic of the present invention and is summarized in that the control signal is a beacon signal indicating that the different radio terminal is located within a distance where the formation of the ad-hoc communication network is possible.

A third characteristic of the present invention is according to the second characteristic of the present invention and is summarized in that the second communication unit sends the different radio terminal a probe request signal for requesting transmission of the control information in a case where the beacon signal does not include the operator identification information.

A fourth characteristic of the present invention is according to the third characteristic of the present invention and is summarized in that the second communication unit receives a probe response signal transmitted from the different radio terminal in response to the probe request signal, and the determination unit makes the determination on the basis of the operator identification information included in the probe response signal.

A fifth characteristic of the present invention is according to the fourth characteristic of the present invention and is summarized in that the second communication unit sends the different radio terminal an operator identification information request signal for requesting transmission of the operator identification information in a case where the probe response signal does not include the operator identification information.

A sixth characteristic of the present invention is according to the fifth characteristic of the present invention and is summarized in that the second communication unit receives an operator identification information response signal transmitted from the different radio terminal in response to the operator identification information request signal, and the determination unit makes the determination on the basis of the operator identification information included in the operator identification information response signal.

A seventh characteristic of the present invention is according to the first characteristic of the present invention and is summarized in that the control signal is a probe response signal transmitted from the different radio terminal in response to a probe request signal for requesting transmission of the control information, the different radio terminal having received the probe request signal sent from the second communication unit.

An eighth characteristic of the present invention is according to the seventh characteristic of the present invention and is summarized in that the second communication unit sends the different radio terminal an operator identification information request signal for requesting transmission of the operator identification information in a case where the probe response signal does not include the operator identification information.

A ninth characteristic of the present invention is according to the eighth characteristic of the present invention and is summarized in that the second communication unit receives an operator identification information response signal transmitted from the different radio terminal in response to the operator identification information request signal, and the determination unit makes the determination on the basis of the operator identification information included in the operator identification information response signal.

A tenth characteristic of the present invention is according to the first characteristic of the present invention and is summarized in that the radio terminal further comprising a comparator (reception sensitivity comparator 137) configured to compare a reception sensitivity of the control signal transmitted by the different radio terminal with a reception sensitivity of a new control signal while the second communication unit is forming the ad-hoc communication network (first ad-hoc communication network AH) with the different radio terminal (different radio terminals MS1 to MS3), the new control signal transmitted from a new radio terminal (new radio terminals MS4 to MS6) which is not included in the ad-hoc communication network formed by the second communication unit and including new control information used in forming a new ad-hoc communication network (second ad-hoc communication network AH2) that is different from the ad-hoc communication network formed by the second communication unit, wherein the determination unit determines whether or not a new connected operator (second connected operator) being a telecommunication operator providing a new connected wide area network (second connected wide area network WAN2) connected to the radio terminal via the new radio terminal is the same as the specific operator on the basis of new operator identification information included in the new control signal and indicating the new connected operator, and the second communication unit forms the new ad-hoc communication network with the new radio terminal in a case where the determination unit determines that the new connected operator is the same as the specific operator, and also, the comparator determines that the reception sensitivity of the new control signal is larger than the reception sensitivity of the control signal.

An eleventh characteristic of the present invention is according to the tenth characteristic of the present invention and is summarized in that the new control signal is a probe response signal transmitted from the new radio terminal in response to a probe request signal for requesting transmission of the new control information, the new radio terminal having received the probe request signal sent from the second communication unit.

A twelfth characteristic of the present invention is according to the tenth characteristic of the present invention and is summarized in that the new control signal is a beacon signal indicating that the new radio terminal is located within a distance where the formation of the new ad-hoc communication network is possible.

A thirteenth characteristic of the present invention is summarized in that a radio communication method used in a radio terminal including a first communication unit configured to be directly communicable with a specific wide area network provided by a specific operator being a specific telecommunication operator, and a second communication unit configured to be capable of forming an ad-hoc communication network with one or more different radio terminals, the method comprising the steps of; receiving, at the second communication unit, a control signal including control information used in forming the ad-hoc communication network; determining, at a determination unit, whether or not a connected operator is the same as the specific operator on the basis of operator identification information included in the control signal and indicating the connected operator, the connected operator being a telecommunication operator providing a connected wide area network connectable to the radio terminal via the different radio terminal; and forming, at the second communication unit, the ad-hoc communication network with the different radio terminal in a case where the determination unit determines that the connected operator is the same as the specific operator.

According to the present invention, it is possible to provide a radio terminal capable of knowing whether or not the radio terminal is allowed to use the connected wide area network to which the ad-hoc communication network is connected before formation of an ad-hoc communication network, and also to provide a radio communication method used in the radio terminal.

### BRIEF DESCRIPTION OF THE DRAWINGS

FIG. 1 is an overall schematic configuration diagram of a radio communication system according to an embodiment of the present invention.

FIG. 2 is a hardware configuration diagram of a radio terminal MS according the embodiment of the present invention.

FIG. 3 is a functional block configuration diagram of the radio terminal MS according to the embodiment of the present invention.

FIG. 4 shows information elements included in a beacon signal according to the embodiment of the present invention.

FIG. 5 shows information elements included in a Capability information field of the beacon signal according to the embodiment of the present invention.

FIG. 6 shows information elements included in a WAN information field of the beacon signal according to the embodiment of the present invention.

FIG. 7 shows information elements included in a probe request signal and a probe response signal according to the embodiment of the present invention.

FIG. 8 shows information elements included in an operator identification information request signal and an operator identification information response signal according to the embodiment of the present invention.

FIG. 9 is a storage table of an operator storage unit 134 according to the embodiment of the present invention.

FIG. 10 is a flowchart showing an operation to form a first ad-hoc communication network AH1 performed by a radio terminal MS10 according to the embodiment of the present invention.

FIG. 11 is a flowchart showing a handoff operation from the first ad-hoc communication network AR1 to a second ad-hoc communication network AH2 performed by the radio terminal MS10 according to the embodiment of the present invention.

### BEST MODE FOR CARRYING OUT THE INVENTION

Next, embodiments of the present invention will be described with reference to the drawings. Specifically, descriptions will be given of (1) Overall Schematic Configuration of Communication System, (2) Configuration of Radio terminal, (3) Operation of Radio terminal, (4) Advantages and Effects, and (5) Other Embodiments.

Note that, in the following descriptions of the drawings in the embodiments, the same or similar reference numerals are given to the same or similar parts.

### (1) Overall Schematic Configuration of Communication System

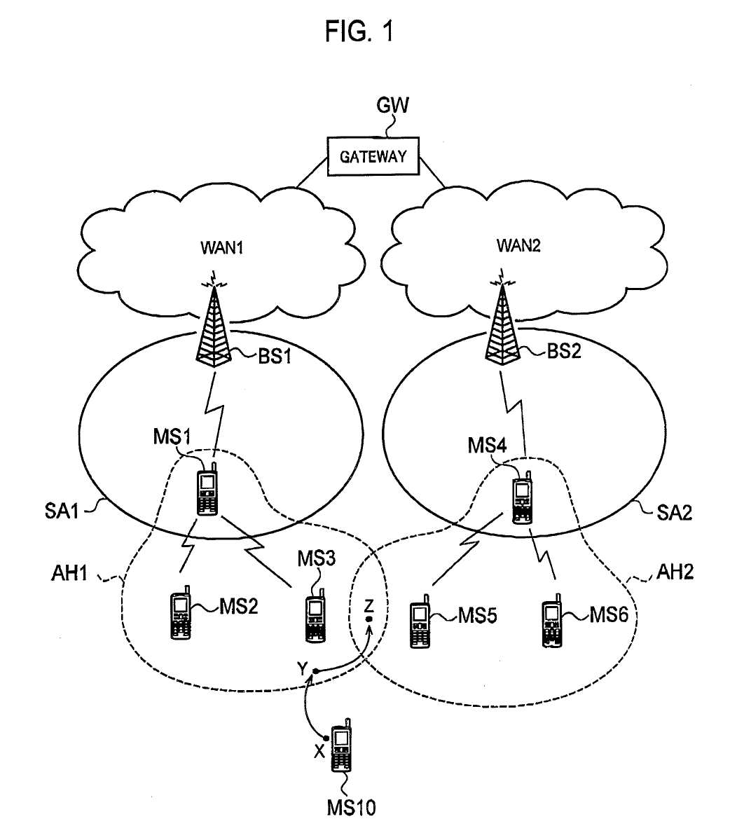

FIG. 1 is an overall schematic configuration diagram of a communication system according to the present embodiment. As shown in FIG. 1, the communication system includes radio base stations BS1 and BS2, and radio terminals MS1 to MS10.

The radio base station BS1 forms a service area (radio wave reachable area) SA1 in which the radio base station BS1 is directly communicable with a radio terminal. In the example of FIG. 1, the radio terminal MS1 located within the service area SA1 is connected to a first connected wide area network WAN1. Specifically, the radio terminal MS1 directly communicates with the radio base station BS1 included in the first connected wide area network WAN1. The first connected wide area network WAN1 is a mobile phone communication network including a radio network controller (RNC), a core network (CN) and the like in addition to the radio base station BS1. The first connected wide area network WAN1 is provided by a first connected telecommunication operator (hereinafter, referred to as a “first connected operator”). Accordingly, a radio terminal which has previously signed a service agreement with the first connected operator is allowed to connect to the first connected wide area network WAN1, i.e., directly communicate with the radio base station BS1.

The radio base station BS2 forms a service area (radio wave reachable area) SA2 in which the radio base station BS2 is directly communicable with a radio terminal. In the example of FIG. 1, the radio terminal MS4 located within the service area SA2 is connected to a second connected wide area network WAN2. Specifically, the radio terminal MS4 directly communicates with the radio base station BS2 included in the second connected wide area network WAN2. The second connected wide area network WAN2 is a mobile phone communication network including an ANC, a CN and the like in addition to the radio base station BS2. The second connected wide area network WAN2 is provided by a second connected telecommunication operator (hereinafter, referred to as a “second connected operator”) that is different from the first connected operator. Accordingly, a radio terminal which has previously signed a service agreement with the second connected operator is allowed to connect to the second connected wide area network WAN2, i.e., communicate with the radio base station BS2.

In this embodiment, the second connected wide area network WAN2 is assumed to be connected to the first connected wide area network WAN1 via a gateway GW, and a radio terminal which has previously signed a service agreement with the first connected operator is assumed to be allowed to connect (perform roaming) to the second connected wide area network WAN2.

Each of the radio terminals MS1 to MS3 includes a function to directly communicate with the first connected wide area network WAN1 provided by the first connected operator, and a function to form a first ad-hoc communication network AH1 with at least one of the different radio terminals. The service agreement with the first connected operator has been previously signed for each of the radio terminals MS1 to MS3.

Each of the radio terminals MS4 to MS6 includes a function to directly communicate with the second connected wide area network WAN2 provided by the second connected operator, and a function to form a second ad-hoc communication network AH2 with at least one of the different radio terminals. The service agreement with the second connected operator has been previously signed for each of the radio terminals MS4 to MS6.

The first ad-hoc communication network AH1 to be autonomously formed by the radio terminals MS1 to MS3 has a tree structure in which the radio terminal MS1 directly communicating with the radio base station BS1 is set at the uppermost level. The first ad-hoc communication network AH1 is connected to the first connected wide area network WAN1 provided by the first connected operator. Accordingly, the radio terminals MS2 and MS3 are capable of connecting to the first connected wide area network WAN1 via the radio terminal MS1.

Moreover, the second ad-hoc communication network AH2 to be autonomously formed by the radio terminals MS4 to MS6 has a tree structure in which the radio terminal MS4 directly communicating with the radio base station BS2 is set at the uppermost level. The second ad-hoc communication network AH2 is connected to the second connected wide area network WAN2 provided by the second connected operator. Accordingly, the radio terminals MS5 and MS6 are capable of connecting to the second connected wide area network WAN2 via the radio terminal MS4.

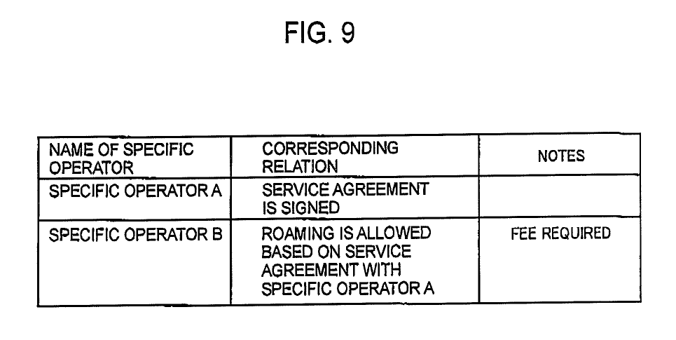

The radio terminal MS10 has a function to directly communicate with a specific wide area network provided by a specific telecommunication operator (hereinafter, referred to as a “specific operator,” refer to FIG. 9) with which a service agreement for the radio terminal MS10 has been previously signed, and a function to autonomously form an ad-hoc communication network with at least one of the radio terminals MS1 to MS6. In this embodiment, the radio terminal MS10 moves from a position X to a position Y and then to a position Z as shown in FIG. 1. Here, since the radio terminal MS10 is located outside the service areas SA1 and SA2, the radio terminal MS10 cannot directly communicate with the first connected wide area network WAN1 and the second connected wide area network WAN2. For this reason, an assumption is made that the radio terminal MS10 desires connection to the first connected wide area network WAN1 or the second connected wide area network WAN2 via any of the radio terminals MS1 to MS6.

Note that, since the radio terminals MS1 to MS10 have the same configuration, the radio terminals MS1 to MS10 are collectively termed as a radio terminal MS as appropriate in the following descriptions. In addition, the first connected wide area network WAN1 and the second connected wide area network WAN2 are together termed as a connected wide area network WAN, and the first ad-hoc communication network AH1 and the second ad-hoc communication network AH2 are together termed as an ad-hoc communication network AH in the following descriptions.

### (2) Configuration of Radio Terminal

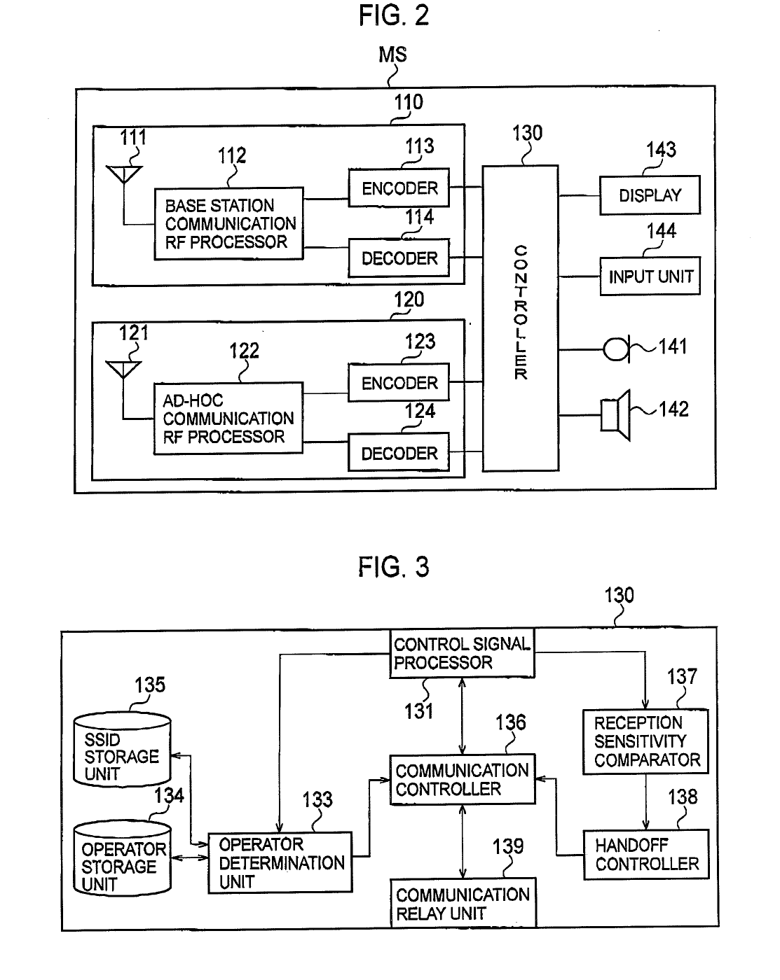

Next, a configuration of the radio Terminal MS will be described with reference to FIGS. 2 through 4. Specifically, (2.1) Hardware Configuration of Radio Terminal and (2.2) Functional Block Configuration of Radio Terminal will be described.

### (2.1) Hardware Configuration of Radio Terminal

FIG. 2 is a hardware configuration diagram of the radio terminal MS. As shown in FIG. 2, the radio terminal MS includes a base station communication unit 110, an ad-hoc communication unit 120, a controller 130, a microphone 141, a speaker 142, a display 143 and an input unit 144.

The base station communication unit 110 is capable of directly communicating with a specific wide area network provided by a specific operator with which a service agreement has been previously signed for the radio terminal MS. Specifically, the base station communication unit 110 transmits and receives a radio signal (RF signal) to and from a radio base station BS in accordance with, for example, a CDMA scheme. In addition, the base station communication unit 110 performs conversion between a radio signal and a baseband signal, and transmits and receives the baseband signal to and from the controller 130.

The ad-hoc communication unit 120 is capable of forming the ad-hoc communication network AH with one or more of different radio terminals MS. Specifically, the ad-hoc communication unit 120 transmits and receives a radio signal (RF signal) to and from the one or more of different radio terminals MS in accordance with, for example, a wireless LAN (IEEE 802.11 or the like) or Bluetooth (registered trademark) scheme. The ad-hoc communication unit 120 performs conversion between a radio signal (including a control signal and an information signal) and a baseband signal, and transmits and receives the baseband signal to and from the controller 130.

The microphone 141 converts sound into an electric signal and then inputs the electric signal to the controller 130. The speaker 142 converts the electric signal from the controller 130 into sound and then outputs the sound.

The display 143 displays an image or operation content (entered phone number or address) received via the controller 130. The input unit 144 is configured of a ten-key, a function key and the like, and receives a user operation.

The controller 130 is configured of a CPU and a memory and controls various functions included in the radio terminal MS. The memory stores therein various information used in the control or the like of the radio terminal MS. The controller 130 and the ad-hoc communication unit 120 cooperatively operate to establish communications via the ad-hoc communication network AH with the connected wide area network WAN connected to the ad-hoc communication network AH.

The base station communication unit 110 includes an antenna 111, a base station communication RF processor 112, an encoder 113 and a decoder 114. The base station communication RF processor 112 performs amplification and down conversion of a radio signal inputted thereto via the antenna 111 and then generates a baseband signal. The encoder 113 encodes a baseband signal from the controller 130. The base station communication RF processor 112 performs up conversion and amplification of the encoded baseband signal. Thereby, a radio signal is generated. The generated radio signal is transmitted to the outside via the antenna 111. The decoder 114 decodes the generated baseband signal and then inputs the decoded baseband signal to the controller 130.

The ad-hoc communication unit 120 includes an antenna 121, an ad-hoc communication RF processor 122, an encoder 123 and a decoder 124. The antenna 121, the ad-hoc communication RF processor 122, the encoder 123 and the decoder 124 have the same functions as those of the antenna 111, the base station communication RF processor 112, the encoder 113 and the decoder 114, respectively. Accordingly, descriptions of the functions of the aforementioned components are omitted herein. The ad-hoc communication unit 120 transmits and receives a control signal including control information used for forming the ad-hoc communication network AH.

### (2.2) Functional Block Configuration of Radio Terminal

FIG. 3 is a block diagram showing each of functions executed by the controller 130. Here, the points related to the present invention will be mainly described below.

As shown in FIG. 3, the controller 130 includes a control signal processor 131, an operator determination unit 133, an operator storage unit 134, an SSID storage unit 135, a communication controller 136, a reception sensitivity comparator 137 and a handoff controller 138.

The control signal processor 131 acquires or generates control signals transmitted and received between the ad-hoc communication unit 120 and a different radio terminal MS.

Here, the control signals include a beacon signal, a probe request signal, a probe response signal, an operator identification information request signal and an operator identification information response signal. Hereinafter, the control signals are described using, as examples, control signals compliant with IEEE 802.11b standard.

### <1> Beacon Signal

The beacon signal indicates that a radio terminal MS is located within a distance where the ad-hoc communication network AH can be formed. The radio terminal MS autonomously and randomly broadcasts the beacon signal. The beacon signal includes control information used in communications with the ad-hoc communication network AH.

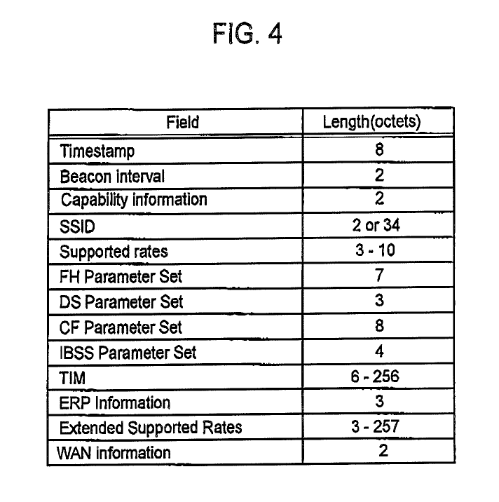

FIG. 4 shows information elements included in the beacon signal. As shown in the drawing, the beacon signal includes an SSID (Service Set ID) field, a Capability information field, a WAN information field and the like. In the SSID field, an identifier for identifying the ad-hoc communication network AH is stored. Specifically, the radio terminal MS is capable of identifying the ad-hoc communication network AH formed by the radio terminal MS broadcasting the beacon signal, on the basis of the SSID field.

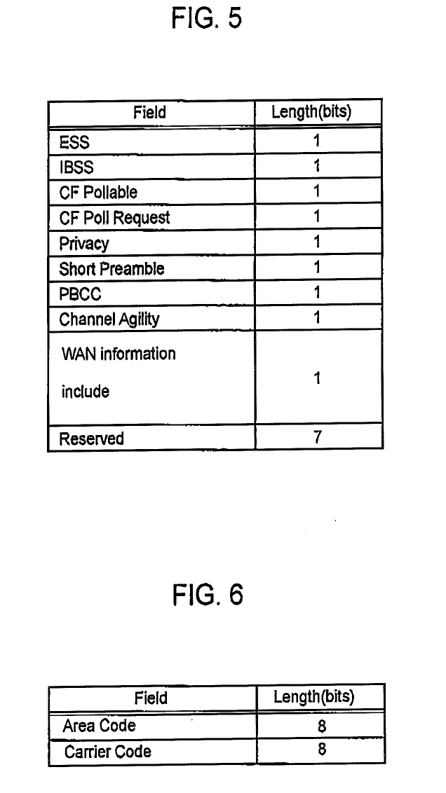

FIG. 5 shows information elements included in the Capability information field. The Capability information field includes a WAN information include field that shows whether or not the WAN information field is included in the beacon signal. When the WAN information field is included in the beacon signal, the record value of the WAN information include field is 1. Meanwhile, when the WAN information field is not included in the beacon signal, the record value of the WAN information include field is 0.

FIG. 6 shows information elements included in the WAN information field. The WAN information field includes an Area Code field and a Carrier Code field. The field length of each of the Area Code field and the Carrier Code field is eight bits.

In the Area Code field, information indicating an area (country name or an area name in a country, for example) where the connected wide area network WAN connected to the ad-hoc communication network AH is provided is stored.

In the Carrier Code field, operator identification information indicating the connected operator (the first connected operator or the second connected operator) is stored, the connected operator being the telecommunication operator providing the connected wide area network WAN to which the ad-hoc communication network AH is connected. The radio terminal MS is capable of identifying the connected operator providing the connected wide area network WAN to which the ad-hoc communication network AH is connected on the basis of the Carrier Code field, i.e., the operator identification information. Here, in the WAN information field, while the Carrier Code field is a required element, the Area Code field is an optional element.

Here, the WAN information field is an optional element in the beacon signal. Specifically, a radio terminal MS is capable of generating a beacon signal not including the WAN information field.

Moreover, a radio terminal at the uppermost level of the ad-hoc communication network AH (radio terminals MS1 and MS4 in FIG. 1) generates the Carrier Code field. A radio terminal MS at a lower level of the ad-hoc communication network AH is capable of storing a Carrier Code field in the WAN information field, the Carrier Code field received from the radio terminal at the uppermost level.

### <2> Probe Request Signal

The probe request signal is a control signal requesting transmission of the control information used in communications is with the ad-hoc communication network AH. The radio terminal MS transmits the probe request signal to a different radio terminal MS located within a distance where the ad-hoc communication network AH MS can be formed. Accordingly, the probe request signal can be also used for checking whether or not a different radio terminal MS capable of forming the ad-hoc communication network AH exists around the radio terminal MS.

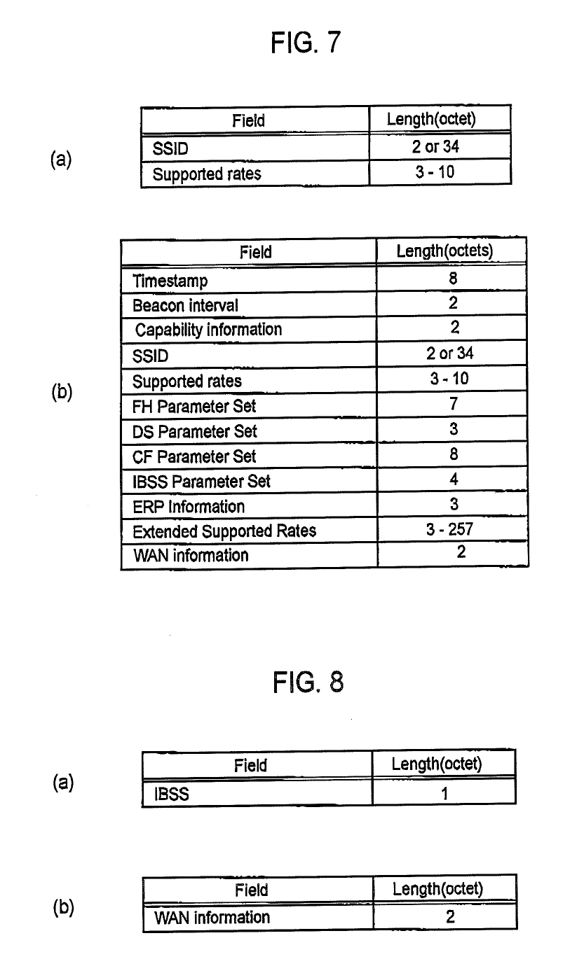

FIG. 7(a) shows information elements included in the probe request signal. The probe request signal includes the aforementioned SSID field.

The radio terminal MS is capable of transmitting the probe request signal at a desired timing (including periodical timing) regardless of whether or not the radio terminal MS is currently forming an ad-hoc communication network AH.

### <3> Probe Response Signal

The probe response signal is a control signal used to respond to a probe request signal when the radio terminal MS receives the probe request signal. FIG. 7(b) shows information elements included in the probe response signal. As shown in the drawing, the information elements included in the probe response signal are the same as the control information included in the beacon signal. Specifically, the probe response signal includes the SSID field, the Capability information field and the WAN information field.

Here, the WAN information field is an optional element in the probe response signal. The radio terminal MS may generate a probe response signal not including the WAN information field.

### <4> Operator Identification Information Request Signal

The operator identification information request signal is a control signal transmitted by the radio terminal MS to a different radio terminal MS located within a distance where an ad-hoc communication network AH can be formed. The radio terminal MS that has received a probe response signal transmits the operator identification information request signal when the WAN information field is not included in the probe response signal. Specifically, the operator identification information request signal is a control signal requesting transmission of the Carrier Code field included in the WAN information field.

FIG. 8(a) shows an information element included in the operator identification information request signal. Here, as described above, the Carrier Code field indicates the operator identification information for identifying the connected operator providing the connected wide area network WAN connected to the ad-hoc communication network AH.

### <5> Operator Identification Information Response Signal

The operator identification information response signal is a control signal transmitted in response to an operator identification information request signal by the radio terminal MS that has received the operator identification information request signal. FIG. 8(b) shows an information element included in the operator identification information response signal. As shown in the drawing, the operator identification information response signal includes the WAN information field. The WAN information field includes the Carrier Code field as a required element, the Carrier Code field indicating the operator identification information.

The control signal processor 131 acquires or generates each of the control signals described above. The control signal processor 131 extracts the SSID information stored in the SSID field and the operator identification information stored in the Carrier Code field from the control signals, and then outputs the information to the operator determination unit 133.

The operator determination unit 133 determines whether or not the connected operator indicated by the operator identification information inputted thereto from the control signal processor 131 is the same as the specific operator. Specifically, the operator determination unit 133 determines whether or not the connected operator indicated by the operator identification information is stored in a later-described storage table of the operator storage unit 134. In a case where the connected operator is the same as the specific operator, the operator determination unit 133 notifies the communication controller 136 accordingly. In addition, the operator determination unit 133 stores the SSID information in the SSID storage unit 135 in this case, the SSID information inputted thereto from the control signal processor 131.

The operator storage unit 134 stores information related to the specific operator with which a service agreement has been previously signed for the radio terminal MS. Here, the specific operator includes not only the telecommunication operator with which a service agreement is directly signed for the radio terminal MS but a telecommunication operator which allows roaming on the basis of the service agreement. As shown in FIG. 9, information on a specific operator A with which the service agreement is directly signed for the radio terminal MS, and information on a specific operator B which allows roaming on the basis of the service agreement with the specific operator A are stored in the storage table of the operator storage unit 134 according to the present embodiment. The operator determination unit 133 determines whether or not the connected operator indicated by the operator identification information is the same as the specific operator A or the specific operator B. Here, as shown in FIG. 9, the storage table stores information indicating that a separate fee is required for connection to the specific wide area network WAN provided by the specific operator B.

Upon receipt of a notice indicating that the connected operator is the same as the specific operator from the operator determination unit 133 while the radio terminal MS is not forming an ad-hoc communication network AH, the communication controller 136 instructs the control signal processor 131 to generate an ad-hoc request signal for requesting formation of an ad-hoc communication network AH.

In addition, upon receipt of a later-described handoff instruction from the handoff controller 138 while the radio terminal MS is forming an ad-hoc communication network AH, the communication controller 136 instructs the control signal processor 131 to generate an ad-hoc request signal requesting formation of a new ad-hoc communication network AH.

Upon receipt of a new control signal from the new radio terminals MS4 to MS6 while the radio terminal MS10 is forming the first ad-hoc communication network AH1 with the different radio terminals MS1 to MS3, the reception sensitivity comparator 137 compares the reception sensitivity of the control signal transmitted from the different radio terminals MS1 to MS3 with the reception sensitivity of the new control signal transmitted from the new radio terminals MS4 to MS6. When the reception sensitivity of the new control signal transmitted from the new radio terminals MS4 to MS6 is larger than the reception sensitivity of the control signal transmitted from the different radio terminals MS1 to MS3, the reception sensitivity comparator 137 notifies the handoff controller 138, accordingly.

The handoff controller 138 notifies the communication controller 136 that the second ad-hoc communication network AH2 is to be newly formed with the new radio terminals MS4 to MS6, on the basis of the notice from the reception sensitivity comparator 137.

In a case where the radio terminal MS is forming an ad-hoc communication network AH, a communication relay unit 139 relays data (packets) transmitted and received to and from a different radio terminal MS.

(3) Operation of Radio terminal

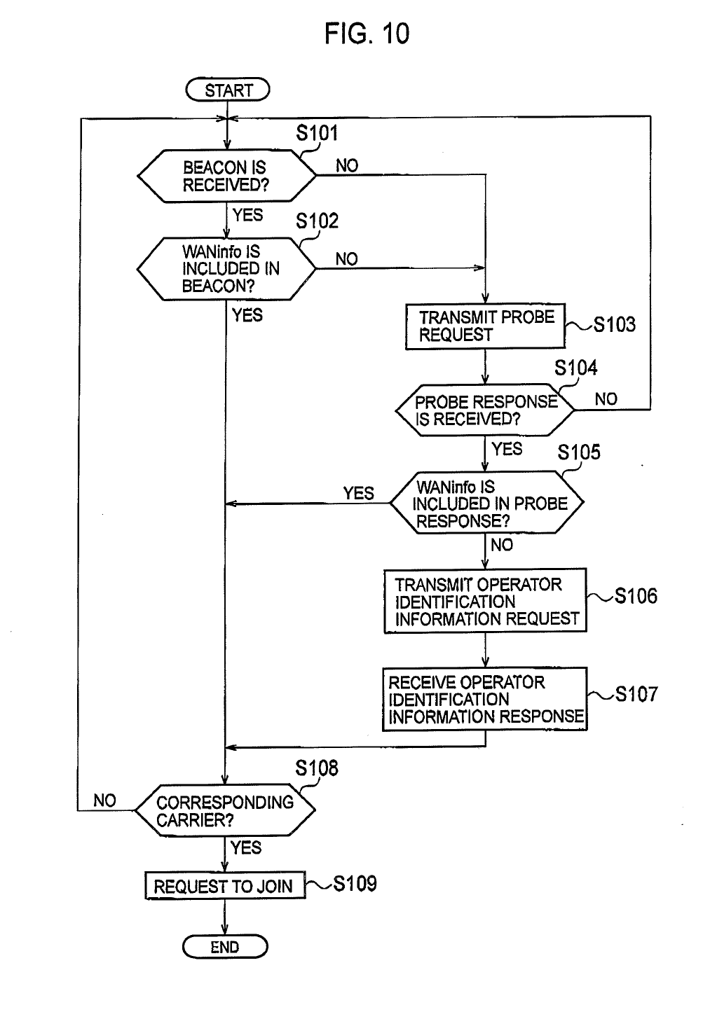

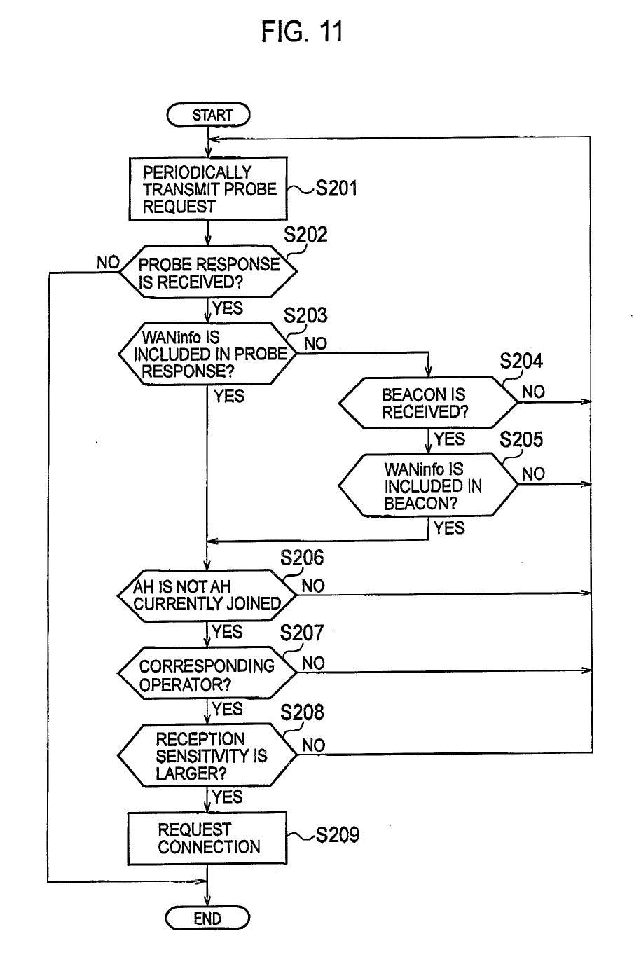

Next, an operation of the radio terminal MS10 will be described with reference to FIGS. 10 and 11. Specifically, the descriptions will be given of (3.1) Operation to Form Ad-hoc Communication Network and (3.2) Handoff Operation, which are performed when the radio terminal MS10 moves from the position X to the position Z in FIG. 1.

### (3.1) Operation to Form Ad-hoc Communication Network

FIG. 10 is a flowchart showing an operation to form the first ad-hoc communication network AH1 performed by the radio terminal MS10 when the radio terminal MS10 moves from the position X to the position Y. The radio terminal MS10 newly joins the first ad-hoc communication network AH1 formed by the different the radio terminals MS1 to MS3.

In step S101, the radio terminal MS10 determines whether or not a beacon signal is received from the different radio terminals MS1 to MS3. If a beacon signal is received from the different radio terminals MS1 to MS3, the radio terminal MS10 determines in step S102 whether or not the WAN information field is included in the beacon signal. Meanwhile, if a beacon signal is not received from the different radio terminals MS1 to MS3, the radio terminal MS10 transmits (broadcasts) a probe request signal to the different radio terminals MS1 to MS3 in step S103.

If the WAN information field is included in the beacon signal in step S102, the processing proceeds to later-described step S108. Meanwhile, if the WAN information field is not included in the beacon signal in step S102, the processing proceeds to step S103.

In step S104, the radio terminal MS10 determines whether or not a probe response signal to be transmitted from the different radio terminals MS1 to MS3 in response to the probe request signal is received. If the radio terminal MS10 receives the probe response signal, the processing proceeds to step S105. If the radio terminal MS10 does not receive the probe response signal, the processing returns to step S101.

In step S105, the radio terminal MS10 determines whether or not the WAN information field is included in the probe response signal. If the WAN information field is included in the probe response signal, the processing moves to step S108. Meanwhile, if the WAN information field is not included in the probe response signal, the radio terminal MS10 transmits an operator identification information request signal to the different radio terminals MS1 to MS3 in step S106, and then receives an operator identification information response signal from any of the different radio terminals MS1 to MS3 in step 107.

In step S108, the radio terminal MS10 determines whether or not the connected operator indicated by the Carrier Code field included in the WAN information field is the same as the specific operator with which a service agreement has been previously signed for the radio terminal MS10. If the connected operator is the same as the specific operator, in step S109, the radio terminal MS10 transmits an ad-hoc request signal requesting to join the first ad-hoc communication network AH1 to the different radio terminals MS1 to MS3. If the connected operator is not the same as the specific operator, the processing returns to step S101.

Here, in this embodiment, since the specific operator A shown in FIG. 9 is the same as the first connected operator, the radio terminal MS10 transmits the ad-hoc request signal to the different radio terminals MS1 to MS3.

### (3.2) Handoff Operation

FIG. 11 is a flowchart showing an handoff operation from the first ad-hoc communication network AH1 to the second ad-hoc communication network AH2, which is performed by the radio terminal MS10 when the radio terminal MS10 moves from the position Y to the position Z.

In step S201, the radio terminal MS10 periodically transmits a probe request signal to a radio terminal MS located within a distance where the ad-hoc communication network AH can be formed.

In step S202, the radio terminal MS10 determines whether or not a probe response signal to be transmitted in response to the probe request signal from a radio terminal MS that has received the probe request signal is received. If the probe response signal is received, the processing moves to step S203. Meanwhile, if the probe response signal is not received, it is determined that there is no radio terminal MS located within the distance where the ad-hoc communication network can be formed, and the processing is terminated.

In step S203, the radio terminal MS10 determines whether or not the WAN information field is included in the probe response signal. If the WAN information field is included in the probe response signal, the processing moves to step S206. Meanwhile, if the WAN information field is not included in the probe response signal, the processing moves to step S204.

In step S204, the radio terminal MS10 determines whether or not a beacon signal is received from a radio terminal MS. If a beacon signal is received, in step S205, the radio terminal MS10 determines whether or not the WAN information field is included the beacon signal. Meanwhile, if a beacon signal is not received, the processing returns to step S201.

If the WAN information field is included in the beacon signal in step S205, the processing moves to step S206. Meanwhile, if the WAN information field is not included the beacon signal, the processing returns to step S201.

In step S206, the radio terminal MS10 determines by checking the SSID field stored in the probe response signal or the beacon signal whether or not the probe response signal or the beacon signal is transmitted from the different radio terminals MS1 to MS3 forming the first ad-hoc communication network AH1 that the radio terminal MS10 has already joined. If the probe response signal or the beacon signal is transmitted from the different radio terminals MS1 to MS3, the processing returns to step S201. If the probe response signal or the beacon signal is transmitted from the new radio terminals MS4 to MS6 forming the new second ad-hoc communication network AH2, the processing moves to step S207.

In step S207, the radio terminal MS10 determines whether or not the connected operator shown by the Operator Code field included in the WAN information field is the same as the specific operator with which a service agreement has been previously signed for the radio terminal MS10. If the connected operator is the same as the specific operator, the processing moves to step S208. Meanwhile, if the connected operator is not the same as the specific operator, the processing returns to step S201. In this embodiment, since the specific operator B shown in FIG. 9 is the same as the second connected operator, the processing moves to step S208.

In step S208, the reception sensitivity of the control signal transmitted from the different radio terminals MS1 to MS3 forming the first ad-hoc communication network AH1 is compared with the reception sensitivity of the control signal transmitted from the new radio terminals MS4 to MS6 forming the second ad-hoc communication network AH2. If the reception sensitivity of the control signal transmitted from the new radio terminals MS4 to MS6 is larger than the reception sensitivity of the control signal transmitted from the different radio terminals MS1 to MS3, the radio terminal MS10 transmits an ad-hoc request signal to the new radio terminals MS4 to MS6 in step S209. Meanwhile, if the reception sensitivity of the control signal transmitted from the new radio terminals MS4 to MS6 is smaller than the reception sensitivity of the control signal transmitted from the different radio terminals MS1 to MS3, the processing returns to step S201.

### (4) Effects and Advantages

According to the present embodiment, the radio terminal MS10 has the function to directly communicate with a specific wide area network provided by the specific operator A or B, and the function to form the first ad-hoc communication network AH1 with one or more of the radio terminals MS1 to MS3. The radio terminal MS10 determines on the basis of the operator identification information included in a beacon signal received from the different radio terminals MS1 to MS3 whether or not the first connected operator is the same as the specific operator A or B, the first connected operator providing the first connected wide area network WAN1 to which the radio terminal MS10 is connected via the different radio terminals MS1 to MS3. If the first connected operator is determined to be the same as the specific operator A or B, the radio terminal MS10 forms the first ad-hoc communication network AH1 with the different radio terminals MS1 to MS3.

As described above, the radio terminal MS10 is capable of determining whether or not the first connected operator is the same as the specific operator A or B before the formation of the first ad-hoc communication network AH1 with the different radio terminals MS1 to MS3. Accordingly, if the radio terminal MS10 does not make the service agreement with the first connected operator, the radio terminal MS10 can know that the radio terminal MS10 is not allowed to use the first connected wide area network WAN1 connectable to the radio terminal MS10 via the different radio terminals MS1 to MS3, without forming the first ad-hoc communication network AH1 with the different radio terminals MS1 to MS3. As a result, the radio terminal MS10 can avoid formation of the first ad-hoc communication network AH1 which might be otherwise carried out even though the connection to the first connected wide area network WAN1 will be denied.

In addition, according to the present embodiment, if the operator identification information is not included in a beacon signal, the radio terminal MS10 transmits a probe request signal for requesting transmission of the control information to the different radio terminals MS1 to MS3. Accordingly, the radio terminal MS10 can perform the determination on the basis of the operator identification information included in a probe response signal to be transmitted from the different radio terminals MS1 to MS3 in response to the probe request signal.

Furthermore, according to the present embodiment, if the operator identification information is not included in the probe response signal, the radio terminal MS10 transmits an operator identification information request signal for requesting transmission of the operator identification information to the different radio terminals MS1 to MS3. Accordingly, the radio terminal MS10 can surely acquire the operator identification information from the operator identification information response signal to be transmitted by the different radio terminals MS1 to MS3 in response to the operator identification information request signal.

Moreover, according to the present embodiment, the radio terminal MS10 performs the following processing when receiving a new control signal from the new radio terminals MS4 to MS6 while the radio terminal MS10 is forming the first ad-hoc communication network AH1 with the different radio terminals MS1 to MS3. Specifically, the radio terminal 10 newly forms the second ad-hoc communication network AH2 with the new radio terminals MS4 to MS6 if the following are true: the second connected operator is determined to be the same as the specific operator, the second connected operator providing the second connected wide area network WAN2 to which the radio terminal MS10 is capable of connecting via the new radio terminals MS4 to MS6; and the reception sensitivity of the new control signal received from the new radio terminals MS4 to MS6 is determined to be larger than the reception sensitivity of a new control signal received from the different radio terminals MS1 to MS3.

Accordingly, when the radio terminal MS10 performs a handoff to the second ad-hoc communication network AH2 having a better communication environment, the radio terminal MS10 can also know before forming the second ad-hoc communication network AH2 with the new radio terminals MS4 to MS6, whether or not the radio terminal MS10 is allowed to use the second connected wide area network WAN2 to which the radio terminal MS10 is to be connected via the new radio terminals MS4 to MS6. As a result, the radio terminal MS 10 can avoid the handoff to the connected wide area network which might be otherwise carried out even though the connection to the first connected wide area network WAN1 will be denied.

### (5) Other Embodiments

Although the present invention has been described through the embodiment as described above, it should not be construed that the descriptions and drawings constituting a part of this disclosure will limit the present invention. Various alternative embodiments, examples, and operation techniques will be apparent to those skilled in the art from this disclosure.

In the aforementioned embodiment, the radio terminal MS10 is configured to determine whether or not a beacon signal transmitted by the different radio terminals MS1 to MS3 is received. However, the radio terminal MS10 may not wait for receiving of the beacon signal, and may periodically broadcast the probe request signal to a radio terminal MS located within a distance where an ad-hoc communication network with the radio terminal MS10 can be formed.

In the aforementioned embodiment, the radio terminal MS10 forms the first ad-hoc communication network AH1 with the multiple different radio terminals MS1 to MS3. However, the radio terminal MS10 is capable of forming the first ad-hoc communication network AH1 with only one of the different radio terminals such as the radio terminal MS1. Likewise, the radio terminal MS10 is capable of forming the second ad-hoc communication network AH2 with only one of the new radio terminals such as the radio terminal MS4.

In the aforementioned embodiment, the radio terminal MS10 uses the SSID field as the identifier showing the ad-hoc communication network AH. However, the radio terminal MS10 may use a BSSID (Basic Service Set identifier) field instead of the SSID field.

In the example of FIG. 1, a mobile phone terminal is exemplified as the radio terminal MS. However, the radio terminal MS may be a notebook PC, a personal digital assistance (PDA) or the like having a radio communication function. Furthermore, the ad-hoc communication network AH may be formed while including not only the portable radio terminal but a fixed type radio terminal.

Note that, in the aforementioned operation to build an ad-hoc communication network, an existing routing protocol such as DSR (Dynamic Source Routing) or AODV (Ad-hoc On-Demand Vector Routing) is also usable.

As described above, it should be understood that the present invention includes various embodiments or the like which have not been described herein. Therefore, the present invention is limited only by specific features of the invention in the claims which are reasonable from the disclosure.

Note that, the entire contents of Japanese Patent Application No. 2007-338113 (filed on Dec. 27, 2007) are incorporated herein by reference.

### INDUSTRIAL APPLICABILITY

As described above, the radio terminal and the radio communication method according to the present invention are advantageous in radio communications such as mobile communications because whether a connected wide area network connectable to an ad-hoc communication network is usable or not can be known before the formation of the ad-hoc communication network.

1. A radio terminal comprising:
a first communication unit configured to be directly communicable with a specific wide area network provided by a certain specific operator being a specific telecommunication operator;
a second communication unit configured to be capable of forming an ad-hoc communication network with one or more different radio terminals; and
a determination unit configured to determines whether or not a connected operator is the same as the specific operator, the connected operator being a telecommunication operator providing a connected wide area network connected to the radio terminal via the different radio terminal, wherein
the second communication unit receives a control signal from the different radio terminal, the control signal including control information used in forming the ad-hoc communication network,
the determination unit makes the determination on the basis of operator identification information included in the control signal and indicating the connected operator, and
the second communication unit forms the ad-hoc communication network with the different radio terminal in a case where the determination unit determines that the connected operator is the same as the specific operator.

2. The radio terminal according to claim 1, wherein the control signal is a beacon signal indicating that the different radio terminal is located within a distance where the formation of the ad-hoc communication network is possible.

3. The radio terminal according to claim 2, wherein the second communication unit sends the different radio terminal a probe request signal for requesting transmission of the control information in a case where the beacon signal does not include the operator identification information.

4. The radio terminal according to claim 3, wherein
the second communication unit receives a probe response signal transmitted from the different radio terminal in response to the probe request signal, and
the determination unit makes the determination on the basis of the operator identification information included in the probe response signal.

5. The radio terminal according to claim 4, wherein the second communication unit sends the different radio terminal an operator identification information request signal for requesting transmission of the operator identification information in a case where the probe response signal does not include the operator identification information.

6. The radio terminal according to claim 5, wherein
the second communication unit receives an operator identification information response signal transmitted from the different radio terminal in response to the operator identification information request signal, and
the determination unit makes the determination on the basis of the operator identification information included in the operator identification information response signal.

7. The radio terminal according to claim 1, wherein the control signal is a probe response signal transmitted from the different radio terminal in response to a probe request signal for requesting transmission of the control information, the different radio terminal having received the probe request signal sent from the second communication unit.

8. The radio terminal according to claim 7, wherein the second communication unit sends the different radio terminal an operator identification information request signal for requesting transmission of the operator identification information in a case where the probe response signal does not include the operator identification information.

9. The radio terminal according to claim 8, wherein
the second communication unit receives an operator identification information response signal transmitted from the different radio terminal in response to the operator identification information request signal, and
the determination unit makes the determination on the basis of the operator identification information included in the operator identification information response signal.

10. The radio terminal according to claim 1, further comprising a comparator configured to compare a reception sensitivity of the control signal transmitted by the different radio terminal with a reception sensitivity of a new control signal while the second communication unit is forming the ad-hoc communication network with the different radio terminal, the new control signal transmitted from a new radio terminal which is not included in the ad-hoc communication network formed by the second communication unit and including new control information used in forming a new ad-hoc communication network that is different from the ad-hoc communication network formed by the second communication unit, wherein
the determination unit determines whether or not a new connected operator being a telecommunication operator providing a new connected wide area network connected to the radio terminal via the new radio terminal is the same as the specific operator on the basis of new operator identification information included in the new control signal and indicating the new connected operator, and
the second communication unit forms the new ad-hoc communication network with the new radio terminal in a case where the determination unit determines that the new connected operator is the same as the specific operator, and also, the comparator determines that the reception sensitivity of the new control signal is larger than the reception sensitivity of the control signal.

11. The radio terminal according to claim 10, wherein the new control signal is a probe response signal transmitted from the new radio terminal in response to a probe request signal for requesting transmission of the new control information, the new radio terminal having received the probe request signal sent from the second communication unit.

12. The radio terminal according to claim 10, wherein the new control signal is a beacon signal indicating that the new radio terminal is located within a distance where the formation of the new ad-hoc communication network is possible.

13. A radio communication method used in a radio terminal including a first communication unit configured to be directly communicable with a specific wide area network provided by a specific operator being a specific telecommunication operator, and a second communication unit configured to be capable of forming an ad-hoc communication network with one or more different radio terminals, the method comprising the steps of:
receiving, at the second communication unit, a control signal including control information used in forming the ad-hoc communication network;
determining, at a determination unit, whether or not a connected operator is the same as the specific operator on the basis of operator identification information included in the control signal and indicating the connected operator, the connected operator being a telecommunication operator providing a connected wide area network connectable to the radio terminal via the different radio terminal; and
forming, at the second communication unit, the ad-hoc communication network with the different radio terminal in a case where the determination unit determines that the connected operator is the same as the specific operator.
